(19) United States
(12) Patent Application Publication
(10) Pub. No.: US 2007/0047603 A1
(43) Pub. Date: Mar. 1, 2007

(54) Optical Transmitter with Monitoring Photodiode Compensated in Temperature Dependence Thereof

(76) Inventor: Hirotaka Oomori, Yokohama-shi (JP)

Correspondence Address: FISH & RICHARDSON P.C., P.O. BOX 1022, MINNEAPOLIS, MN, 55440-1022, US

(21) Appl. No.: 11/466,599

(22) Filed: Aug. 23, 2006

(30) Foreign Application Priority Data
Aug. 23, 2005 (JP) P2005-241355

(51) Int. Cl. H01S 3/13; H01S 3/04; H01S 3/00

(52) U.S. Cl. 372/34; 372/38.07; 372/29.011

(57) ABSTRACT

The optical transmitter according to the present invention is capable of reducing wavelength fluctuations of a semiconductor laser (laser diode) owing to the temperature dependence of the light reception sensitivity of the monitoring photodiode. The optical transmitter comprises an optical transmitting module, an LD driver, a temperature sensor, a memory, a compensation circuit, and a controller. The optical transmitting module has a laser diode and a photodiode that monitors the light from the laser diode mounted thereon. The compensation circuit obtains the parameter corresponding with the temperature of the photodiode sensed by the temperature sensor from the memory and uses the parameter to compensate the signal which is then supplied to the controller. The controller controls the driving current of the LD driver on the basis of the difference between the compensated signal and the reference level.

### BACKGROUND OF THE INVENTION

1. Field of the Invention

The present invention relates to an optical transmitter.

2. Related Background Art

An optical transmitter comprises an optical transmitting module of a type known as the so-called coaxial type. The coaxial-type optical transmitting module contains a thermoelectric controller (TEC) for keeping the temperature of the LD (Laser Diode) constant and is described in a Japanese Patent Application Published as No. 2003-142766A, for example. The optical transmitting module installs an LD on the heat-absorbing plate of the TEC and a monitoring photodiode (referred to simply as a ‘PD’ (photodiode) hereinbelow) that monitors light emitted from the LD.

Further, in order to achieve the low power consumption, a PD with a large heat capacity is provided in a different portion from the heat-absorbing plate in the TEC-installing optical transmitting module. However, in such optical transmitting module, the optical sensitivity of the PD varies depending on the ambient temperature. As a result, the driving current of the LD fluctuates and the wavelength of the output light of the LD varies.

### SUMMARY OF THE INVENTION

The optical transmitter according to the present invention comprises an optical transmitting module that installs an LD and a PD, a temperature sensor that monitors the temperature of the PD, a memory for storing compensation parameters, a compensation circuit for compensating the output of the PD on the basis of the compensation parameters, and a controller for supplying current to the LD based on a comparison between the compensated output and the predetermined reference signal. The compensation parameters are stored in a look-up table in the memory against the temperature. The temperature of the PD is monitored by the temperature sensor, the compensation parameters are read from the memory based on the temperature thus monitored, and the output of the PD is compensated.

Alternatively, the optical transmitter according to the present invention comprises an optical transmitting module that contains an LD and a PD, a temperature sensor that monitors the temperature of the PD, a reference generator that generates a reference level, a memory that stores compensation parameters, a reference signal generator for generating a reference signal, and a controller that adjusts the current supplied to the LD based on the difference between the output of the PD and the reference signal. Here, the reference signal generator reads compensation parameters from the memory based on the temperature of the PD monitored by the temperature sensor and sends a reference signal that is compensated by the compensation parameters to the controller.

The LD shifts the wavelength of the emitted light toward longer wavelengths due to the self-heating when excess current is supplied. With the optical transmitter according to the present invention, the output of the PD is compensated by the compensation parameters stored in the memory and, accordingly, even in a high-temperature in which the optical sensitivity of the PD lowers, the true magnitude of the optical output from the LD can be determined, an excess current can be prevented from being supplied to the LD, and a red-shift of the wavelength of the emitted light can be prevented.

### BRIEF DESCRIPTION OF THE DRAWINGS

FIG. 1 shows the configuration of the optical transmitter according to the first embodiment of the present invention;

FIG. 2 is a perspective and partially exploded view of the optical transmitting module according to the embodiment of the present invention;

FIG. 3 is a graph showing the temperature dependence of the optical sensitivity of the PD;

FIG. 4 shows the relationship of the temperature of each part in the optical link against the ambient temperature; and

FIG. 5 shows the configuration of the optical transmitter according to a second embodiment of the present invention.

### DETAILED DESCRIPTION OF THE PREFERRED EMBODIMENTS

In the following, preferred embodiments of the present invention will be described in detail with reference to the drawings hereinbelow. The same numerals are assigned to the same or equivalent parts in the respective drawings.

### First Embodiment

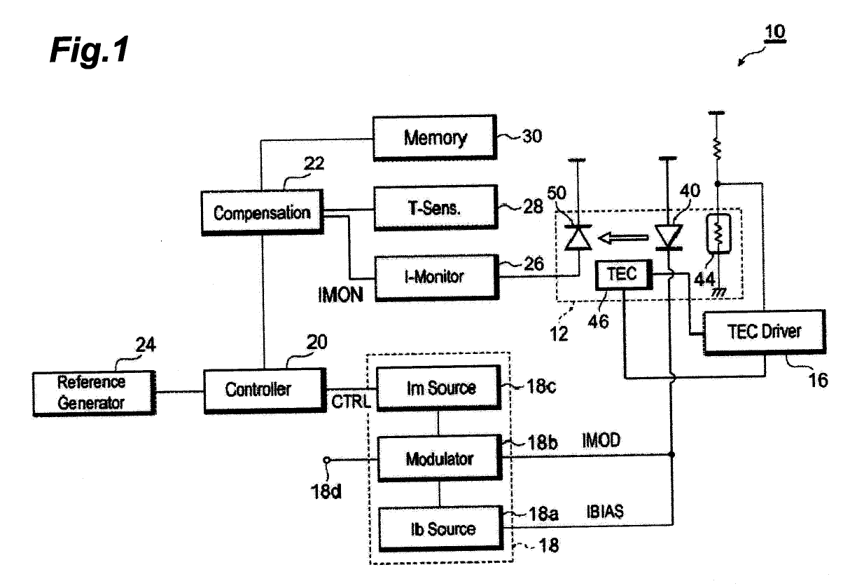

FIG. 1 is a block diagram of an optical transmitter according to a first embodiment of the present invention. The optical transmitter 10 shown in FIG. 1 comprises an optical transmitting module 12, a TEC driver 16, an LD driver 18, a controller 20, a compensation circuit 22, a reference generator 24, a current monitor 26, a temperature sensor 28, and a look-up table (storage means) 30.

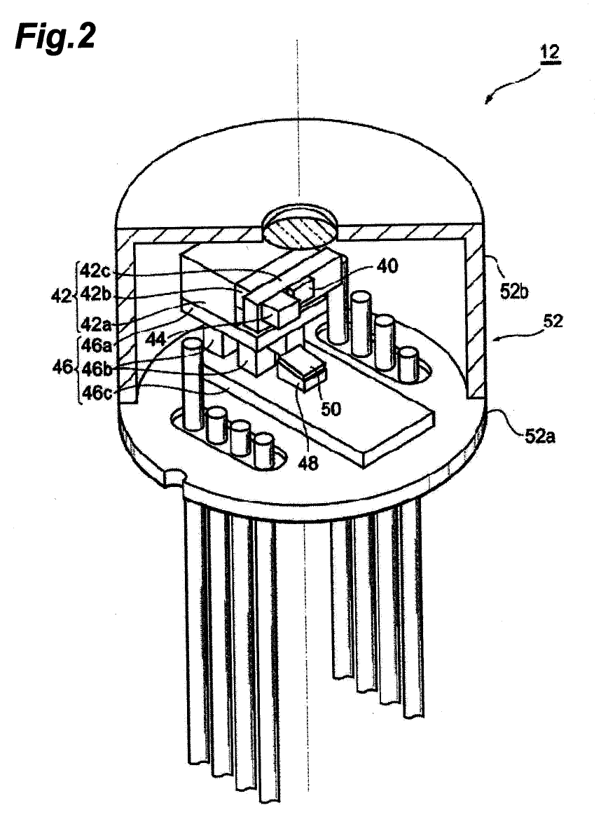

FIG. 2 is a perspective and partially exploded view of the optical transmitting module according to the embodiment of the present invention. As shown in FIG. 2, the optical transmitting module 12 comprises an LD 40, a first carrier 42, a thermistor 44, a thermoelectric controller (‘TEC’ hereinbelow) 46, a PD carrier 48, a PD 50, and a housing 52. The optical transmitting module of FIG. 2 comprises a coaxial-type housing comprising a stem 52a and a cap 52b as the housing 52. The LD 40, the PD 50, and the TEC 46 are hermetically sealed in the space formed by the stem 52a and the cap 52b.

The LD 40 is mounted on the upper plate 46a of the TEC 46 via a plurality of carriers 42a, 42b, and 42c. The TEC 46 is comprised of an upper plate 46a that operates as a heat absorber, a lower plate 46c that operates as a radiating fin, and a plurality of Peltier elements 46b interposed between the upper and lower plates. In the case of the TEC 46 of this embodiment, the size of the lower plate 46c is larger than that of the upper plate 46a and the PD 50 is mounted on the lower plate 46c of the TEC 46 via the PD carrier 48.

The LD driver 18 comprises a bias current source 18a, a modulator 18b, and a modulation current source 18c. The bias current source 18a supplies a bias current IBIAS to the LD 40. The modulator 18b receives an RF signal that is input to the input terminal 18d and modulates the current switching. The modulation current source 18c supplies a modulation current IMOD to the LD 40 via the modulator 18b. The magnitude of the modulation current IMOD supplied by the modulation current source 18c is controlled by a control signal CTRL sent from the controller 20. The controller 20 supplies the control signal CTRL to the modulation current source 18c based on the current output from the PD 50 in order to keep the optical output of the LD40 constant. Hence, the controller 20 outputs a control signal that reflects the difference between the signal from the compensation circuit 22 and the predetermined reference level from the reference generator to the modulation current source 18c.

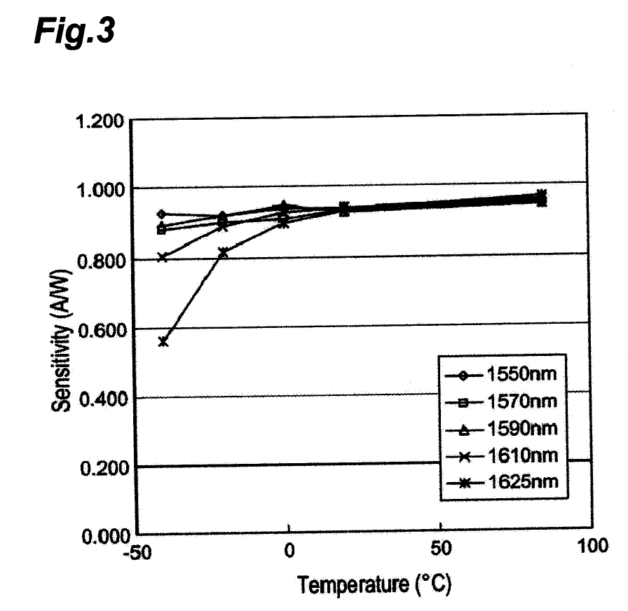

Here, the temperature dependence of the optical sensitivity of the PD 50 will be described. FIG. 3 is a graph that shows the temperature dependence of the optical sensitivity of the PD. FIG. 3 shows the temperature dependence of the optical sensitivity for various wavelengths. The PD used here is a PD in which the optical sensitivity for the light of a wavelength of 1550 nm (C-band) is substantially independent on the temperature. As shown in FIG. 3, for a PD with the optical sensitivity substantially independent on the temperature in the C-band, some temperature dependence of the optical sensitivity may occur for the light with a wavelength of 1625 nm (L band). Specifically, the optical sensitivity decreases at low temperatures.

Therefore, in an optical transmitter that converts photocurrent from the PD into a monitored signal (in a voltage form) and inputs the monitored signal to a controller, the LD 40 is applied as one for the L band and, when the ambient temperature changes, specifically changes to a low temperature, a phenomenon that the optical output from the LD 40 becomes small is appeared due to the temperature characteristic of the PD 50 and an excess modulation current is supplied to the LD 40 in order to compensate the reduction of the optical output. To provide an excess current to the LD 40 causes the temperature increase of the LD 40 and, as a result, the wavelength of the output light from the LD40 shifts. More specifically, the wavelength of the output light from the LD 40 shifts toward longer wavelengths.

In order to compensate this phenomenon, the optical transmitter 10 according to the present embodiment is configured such that a compensated signal for compensating the monitored signal is output to the controller in accordance with the temperature of the PD 50. Specifically, as shown in FIG. 1, the current monitor 26, the temperature sensor 28, and the look-up table (‘LUT’ hereinbelow) 30 are connected to the compensation circuit 22.

The current monitor 26 comprises a current-to-voltage converter and an analog-to-digital converter (A/D-C). In the current monitor 26, the photocurrent output from the PD 50 is first converted to a voltage signal by the current-to-voltage converter. The voltage signal is output to the compensation circuit 22 via the A/D-C. The temperature sensor 28 monitors the temperature of the PD 50. The temperature sensor 28 outputs a voltage signal corresponding to the temperature to the compensation circuit 22. In this embodiment, the temperature sensor 28 can be mounted outside the optical transmitting module 12.

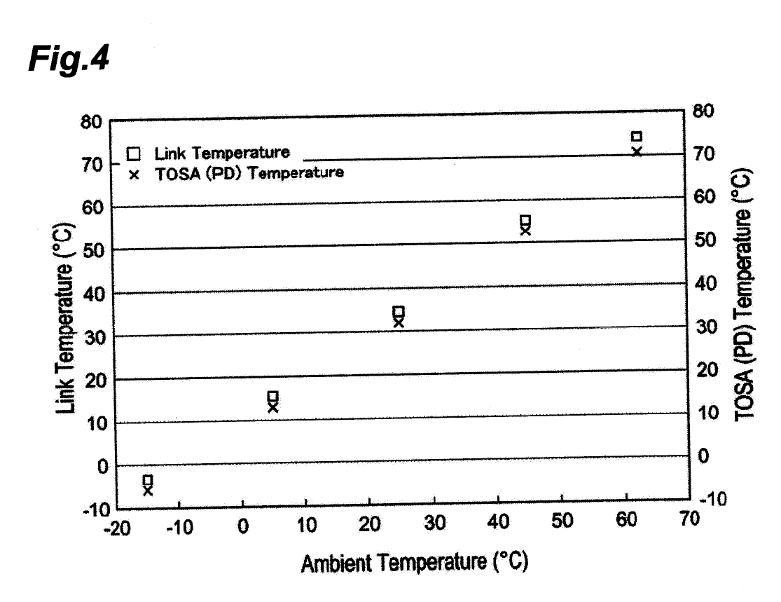

FIG. 4 shows the relationship between the temperature of the respective elements of the optical link in which the optical transmitter 10 is mounted and the ambient temperature outside the optical link. In FIG. 4, the left-hand vertical axis ‘link temperature’ denotes the temperature inside the optical link and outside the optical transmitting module 12 and the right-hand vertical axis ‘TOSA (PD) temperature’ denotes the temperature of the PD 50. Further, the temperature of the PD 50 is the temperature of the stem 52a of the optical transmitting module 12. The PD 50 is mounted on the stem 52a via the lower plate 46c and therefore the temperature of the stem 52a and the temperature of the PD 50 substantially match.

As shown in FIG. 4, even when the ambient temperature outside the optical link varies, only a few degree centigrade in the temperature is appeared between an area that mounts the PD and other areas within the optical link, although about 5° C. increase is apparent in the temperature of the optical link outside the optical transmitting module, namely, within the optical link, with respect to the temperature of the PD due to the heat generation by electronic parts installed within the optical link. Such difference can be ignored after compensating the voltage signal based on the temperature characteristic of the PD in FIG. 3.

Returning now to FIG. 1, the LUT 30 is comprised of a CPU and a memory and stores parameters against the temperature of the PD 50. When setting a certain temperature as the reference temperature, assuming the optical sensitivity of the PD 50 at the reference temperature as ηS and assuming the optical sensitivity of the PD 50 at a temperature T other than this reference temperature as ηT, the parameters can be written as ηS/ηT. The compensation circuit 22 obtains the parameter ηS/ηT corresponding to the temperature T monitored by the temperature sensor 28 from the LUT 30 and generates a compensated signal by calculating the monitored signal I multiplexed by the parameter ηS/ηT. The compensated signal is output to the controller 20 and the difference between the compensated signal and reference level is fed back to the modulation current source 18c by the controller 20.

With the optical transmitter 10, the monitored signal is compensated based on the temperature of the PD 50. Hence, an excess modulation current is not supplied to the LD 40 (caused by the temperature dependence of the optical sensitivity of the PD 50.) As a result, the wavelength shifts of the LD 40 are reduced. In addition, because the temperature sensor 28 can be provided outside the optical transmitting module 12, which results on a freely selection of the temperature sensor 28.

### Second Embodiment

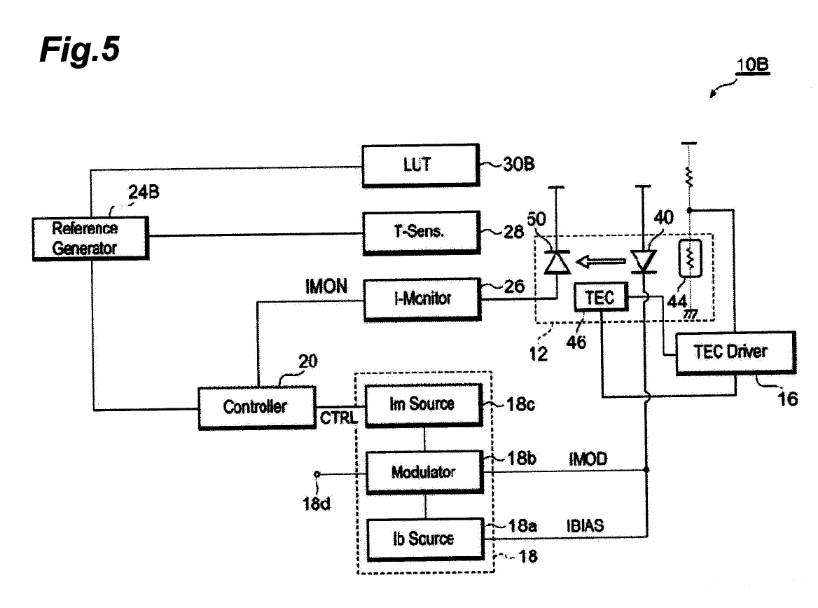

The optical transmitter according to the second embodiment of the present invention will be described hereinbelow. FIG. 5 is a block diagram of the optical transmitter of the second embodiment of the present invention. Although the monitored signal has been compensated by the optical transmitter 10 according to the first embodiment, the reference level that is output by a reference generator 24B is compensated by the optical transmitter 10B shown in FIG. 5 based on the temperature of the PD 50. The points by which the optical transmitter 10B differs from the optical transmitter 10 will be described hereinbelow.

As shown in FIG. 5, in the optical transmitter 10B, the current monitor 26 is directly connected to the controller 20 and the controller 20 directly obtains the signal IMON. Furthermore, the temperature sensor 28 and LUT 30B are connected to the reference generator 24B. The LUT 30B stores parameters that correspond to the temperature of the PD 50 as described previously. Assuming that the optical sensitivity of the PD 50 at the reference temperature is ηS and the optical sensitivity of the PD 50 at a certain temperature T is ηT, the parameter is then ηT/ηS.

The reference generator 24B obtains the parameter ηT/ηS that corresponds to the temperature T monitored by the temperature sensor 28 from the LUT 30B, calculates the predetermined reference level V multiplexed by the parameter ηS/ηT, and determines the corrected reference. The controller 20 feeds back the difference between the corrected reference and the signal I to the modulation current source 18c. Thus, even when the reference level can be varied depending on the temperature of the PD 50, the wavelength shifts of the LD 40 due to the temperature dependence of the optical sensitivity of the PD 50 can be reduced.

The concepts of the present invention has been illustrated and described as referring to the preferred embodiments. However, the present invention is not limited to the specified configurations of the embodiments. For example, the compensating parameter in the first embodiment may be ηT/ηS and, in this case, the control signal is generated by dividing the signal IMON and the parameter ηT/ηS. While, the compensating parameter in the second embodiment may be ηS/ηT and, in this case, the corrected reference is determined by a predetermined reference level V divided by the parameter ηS/ηT. Moreover, although only the modulation current was controlled in the embodiments above, a bias current can also be controlled in addition to the modulation current.

What is claimed is:

1. An optical transmitter, comprising:
an optical transmitting module including a semiconductor laser diode for emitting light by supplying a driving current and a semiconductor photodiode for outputting a signal by monitoring the light emitted from the laser diode, the photodiode having sensitivity depending on temperatures;
a temperature sensor for monitoring a temperature of the photodiode;
a memory for storing compensation parameters relating to temperatures;
a compensation circuit configured to compensate the signal based on the temperature of the photodiode monitored by the temperature sensor and the compensation parameters stored in the memory, the compensation circuit outputting a compensated signal; and
a controller for adjusting the current supplied to the laser diode based on a difference between the compensated signal and a predetermined reference level.

2. The optical transmitter according to claim 1,
wherein the optical transmitting module further includes a thermoelectric controller including Peltier elements put between an upper plate and a lower plate,
wherein the laser diode is mounted on the upper plate and the photodiode is mounted on the lower plate.

3. The optical transmitter according to claim 2,
wherein the optical transmitting module further includes a housing with a coaxial shape, the housing including a stem and a cap to form a cavity where the laser diode, the photodiode, and the thermoelectric controller are enclosed, and
wherein the thermoelectric controller is mounted on the stem.

4. The optical transmitter according to claim 1,
wherein the temperature sensor is mounted outside the optical transmitting module.

5. The optical transmitter according to claim 1,
wherein the compensation parameters are stored within the memory in a configuration of a look-up table.

6. An optical transmitter, comprising:
an optical transmitting module including a semiconductor laser diode for emitting light by supplying a current and a semiconductor photodiode for outputting a signal by monitoring the light emitted from the laser diode, the photodiode having sensitivity depending on temperatures;
a temperature sensor for monitoring a temperature of the photodiode;
a memory for storing compensation parameters relating to temperatures;
a reference generator for generating a reference signal; and
a controller for adjusting the current supplied to the laser diode based on a difference between the signal output from the photodiode and the reference signal,
wherein the reference generator outputs the reference signal compensated by the compensation parameters based on the temperature of the photodiode monitored by the temperature sensor.

7. The optical transmitter according to claim 6,
wherein the optical transmitting module further includes a thermoelectric controller including Peltier elements put between an upper plate and a lower plate, and
wherein the laser diode is mounted on the upper plate and the photodiode is mounted on the lower plate.

8. The optical transmitter according to claim 7,
wherein the optical transmitting module further includes a housing with a coaxial shape, the housing including a stem and a cap to form a cavity where the laser diode, the photodiode, and the thermoelectric controller are enclosed, and
wherein the thermoelectric controller is mounted on the stem.

9. The optical transmitter according to claim 6,
wherein the temperature sensor is mounted outside the optical transmitting module.

10. The optical transmitter according to claim 6,
wherein the parameters are stored within the memory in a configuration of a look-up table.
